(19) United States
(12) Patent Application Publication
(10) Pub. No.: US 2010/0294138 A1
(43) Pub. Date: Nov. 25, 2010

(54) VERSATILE COOKING DEVICE

(75) Inventors: Donald William Bryce, Natick, MA (US); Wing Sun (Felix) Wong, Ashland, MA (US); Robert Scott Ashworth, Littleton, MA (US); Kris David Kahn, Boston, MA (US); Chan Siu Kei, San Francisco, CA (US)

Correspondence Address: FRANCIS EDWARD MARINO, 394 MEREDITH NECK ROAD, MEREDITH, NH, 03253, US

(73) Assignee: JORDAN KAHN COMPANY, Newton, MA (US)

(21) Appl. No.: 12/757,672

(22) Filed: Apr. 9, 2010

Related U.S. Application Data
(60) Provisional application No. 61/180,349, filed on May 21, 2009.

(51) Int. Cl. A47J 37/07

(52) U.S. Cl. 99/450

(57) ABSTRACT

Disclosed are accessories for use on the cooking grate of a barbeque grill or such, which are adapted to enable the effective grilling of such food items as fish, pizza, small items, and delicate items, alone of in combination, and which overcome drawbacks of grilling such food items while allowing the food items to receive the flavor benefits of grilling.

### RELATED APPLICATION

This application is a Continuation of and claims the benefit of pending U.S. Provisional Application S/N No. 61/180,349, filed May 21, 2009, the entire teachings of which are incorporated herein by reference.

### FIELD OF THE INVENTION

The present invention is related to food grilling and to accessories for use therein. More specifically, this invention is related to a versatile cooking device for use on grills, such as barbeque grills, for improving or enabling the grilling of non-traditional, small, or delicate foods.

### BACKGROUND

The benefits of grilling as a method of cooking are well known. Grilling provides improved flavor over other forms of cooking in many cases. Grilling reduces the fat content of foods. As part of a package of outdoor activities, grilling is an experience that cannot be achieved through indoor cooking. But grilling if certain non-traditional, small, and delicate foods has numerous drawbacks and disadvantages, including failures of convenience and function.

For instance, the grilling of delicate fish on the cooking grate of a traditional barbeque is impractical and ineffective. The large spacings of the grate allow the fish to break apart during cooking and fall there-through. Fish is particularly susceptible to being overly dried-out during cooking, which is an especially acute problem when grilling. Wrapping fish in aluminum foil to prevent breakage and drying denies exposure to the flavor benefits of grilling. There exists the need to enable the grilling of fish on a barbeque which prevents the fish from falling apart and drying out, but which allows exposure to the flavor benefits of grilling, and such is an object of the present invention.

There exists the need to enable such grilling of fish by an accessory that is useful with existing grills, so that owners of such expensive grills can easily adapt their grills for cooking fish without the need to purchase a new grill, and such is an object of the invention. There exists the need for such an accessory that can be brought to the sink or placed in the dishwasher for cleaning, and such is another object of the invention.

Additionally, the grilling of small food items, such as small vegetables on the cooking grate of a traditional barbeque is impractical and ineffective. The large spacings of the grate allow the items to fall there-through. Wrapping such items in aluminum foil to prevent falling through denies exposure to the flavor benefits of grilling. There exists the need to enable the grilling of small food items on a barbeque which prevents them from falling through the grate, but which allows exposure to the flavor benefits of grilling, and such is an object of the present invention.

There exists the need to enable such grilling of small food items by an accessory that is useful with existing grills, so that owners of such expensive grills can easily adapt their grills for cooking such small items without the need to purchase a new grill, and such is an object of the invention. There exists the need for such an accessory that can be brought to the sink or placed in the dishwasher for cleaning, and such is another object of the invention.

Additionally, the grilling of non-traditional food items, such as pizza on the cooking grate of a traditional barbeque is impractical and ineffective. The direct exposure of the underside of the pizza to the cooking flame, and the inability to “flip” the pizza over during cooking, result in pizza that is burnt on its underside long before the toppings are cooked. There exists the need to enable the grilling of pizza on a barbeque which insulates the underside of the pizza from the cooking flame while allowing the toppings to be cooked during exposure to the flavor benefits of grilling, and such is an object of the present invention.

There exists the need to enable such grilling of pizza by an accessory that is useful with existing grills, so that owners of such expensive grills can easily adapt their grills for cooking pizza without the need to purchase a new grill, and such is an object of the invention. There exists the need for such an accessory that can be brought to the sink or placed in the dishwasher for cleaning, and such is another object of the invention.

Additionally, the simultaneous grilling in some combination of fish, small food items, and non-traditional food items, such as pizza on the cooking grate of a traditional barbeque is impractical and ineffective. There exists the need to enable the simultaneous grilling of such foods in various combinations, and such is an object of the present invention.

There exists the need to enable such simultaneous grilling of such foods in various combinations by an accessory that is useful with existing grills, so that owners of such expensive grills can easily adapt their grills therefore without the need to purchase a new grill, and such is an object of the invention. There exists the need for such an accessory that can be brought to the sink or placed in the dishwasher for cleaning, and such is another object of the invention.

Further needs and objects exist are addressed by the present invention, as may become apparent upon review of the included disclosure of exemplary embodiments thereof.

### SUMMARY OF THE INVENTION

The invention may be practiced in an accessory for use on the cooking grate of a barbeque grill or such, which is adapted to enable the effective grilling of such food items as fish, pizza, small items, and delicate items, alone of in combination, and which overcomes the afore-stated drawbacks while allowing the food items to receive the flavor benefits of grilling.

To accomplish this, the invention may be practiced in a grilling device comprising a planar slab and a metal panel, the metal panel comprising a perforated first segment, a second segment adapted to removably receive the slab, and a barrier dividing the first and second segments. The planar slab may be from the group including a wooden plank, a stone tile, and a ceramic tile. The perforated first segment may comprise perforations of minor dimension smaller than approximately three-eighths of an inch. The second segment may be a perforated second segment. The perforated second segment may comprise perforations of minor dimension smaller than approximately three-eighths of an inch. The metal panel may further comprise a non-perforated third segment. The planar slab may also be from the group including a circular stone tile and a circular ceramic tile.

The invention may otherwise be practiced in a metal grilling panel comprising a perforated first segment, a second segment, and a barrier dividing the first and second segments. The perforated first segment may comprise perforations of minor dimension smaller than approximately three-eighths of an inch. The second segment may be a perforated second segment. The perforated second segment may comprise perforations of minor dimension smaller than approximately three-eighths of an inch. The panel may further comprise a non-perforated third segment.

The invention may otherwise be practiced in a grilling device comprising first and second planar slabs, and a metal panel comprising a first segment adapted to removably receive the first slab, a second segment adapted to removably receive the second slab, and a barrier dividing the first and second segments. The first planar slab may be from the group including a stone tile and a ceramic tile. The first planar tile may be circular. The second planar slab may comprise a wooden plank. The first segment may comprise perforations of minor dimension smaller than approximately three-eighths of an inch. The second segment may comprise perforations of minor dimension smaller than approximately three-eighths of an inch. The panel may further comprise a non-perforated third segment.

### BRIEF DESCRIPTION OF THE DRAWINGS

Many aspects of the invention can be better understood with reference to the included Drawings showing representative embodiments for practicing the invention which correspond to the accompanying Detailed Description. The components in the Drawings are not necessarily to scale, emphasis instead being placed upon clearly illustrating the principles of the invention. Moreover, like reference numerals in the Drawings designate corresponding parts throughout the several views.

FIG. 1 is an exploded perspective view of an accessory for cooking non-traditional foods on a grill according to a first exemplary embodiment for practicing the invention;

FIG. 2 is a top view of the base of accessory of FIG. 1;

FIG. 3 is a perspective view showing the accessory of FIG. 1 on a countertop barbeque grill;

FIG. 4 is a perspective view showing the accessory of FIG. 1 on a full-size barbeque grill;

FIG. 5 is a perspective view showing the accessory of FIG. 1 in preparation for grilling a piece of fish and a pizza;

FIG. 6 is a perspective view showing the accessory of FIG. 1 in preparation for grilling a piece of fish and some vegetables;

FIG. 7 is a perspective view showing the accessory of FIG. 1 in preparation for grilling a pizza and some mushrooms;

FIG. 8 is a partial cross sectional view of the accessory of FIG. 1 on the grate of a grill;

FIG. 9 is an exploded view of an accessory for cooking non-traditional foods on a grill according to a second exemplary embodiment for practicing the invention; and

FIG. 10 is a perspective view of the accessory of FIG. 9 in preparation for grilling various food items.

### DETAILED DESCRIPTION OF EXEMPLARY EMBODIMENTS

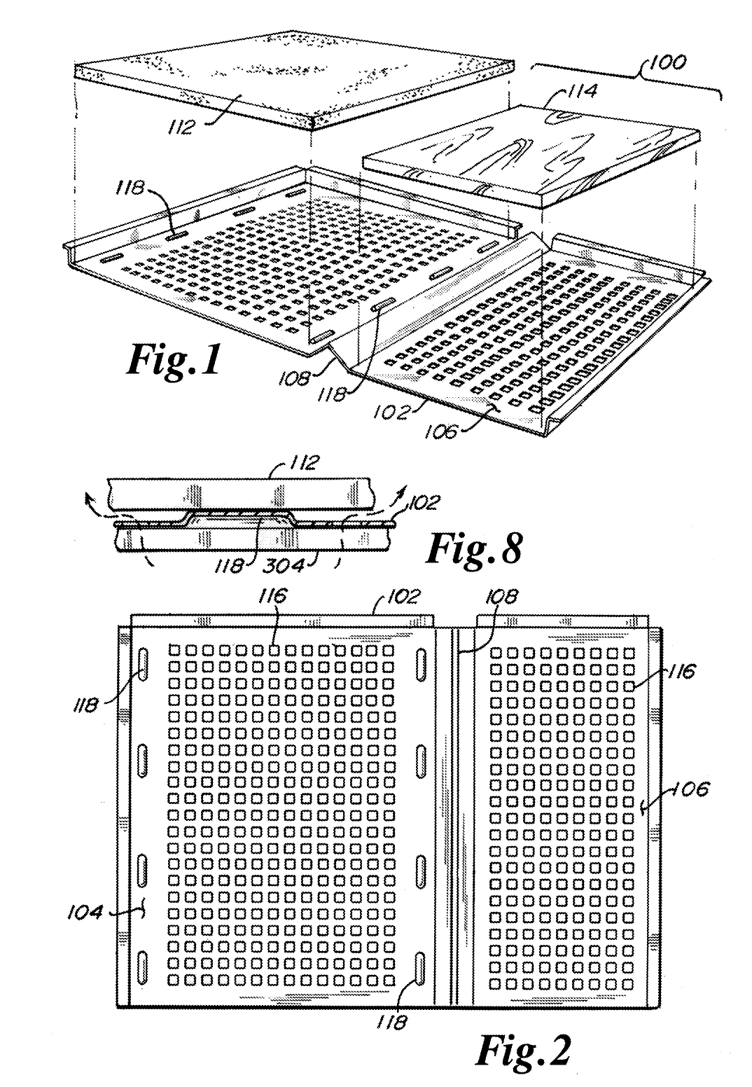

A first embodiment of a versatile cooking device 100 according to one example of the invention is shown in FIGS. 1 through 7, and enables the grilling of non-traditional, small, or delicate foods without sacrificing flavor or culinary quality. Its main structure is a metal grilling panel 102, divided into two segments; first segment 104 and second segment 106, by barrier 108. The panel is preferably made of stainless steel, or may be aluminum or some other metal. It may be covered by a non-stick coating, such as polytetrafluoroethylene (Teflon). As seen in FIGS. 1 and 2, the larger first segment is associated with a ceramic or stone tile 112 for cooking foods like pizza or bread, and the smaller second segment is associated with a wooden plank 114 for cooking foods like fish, chicken, or other meats.

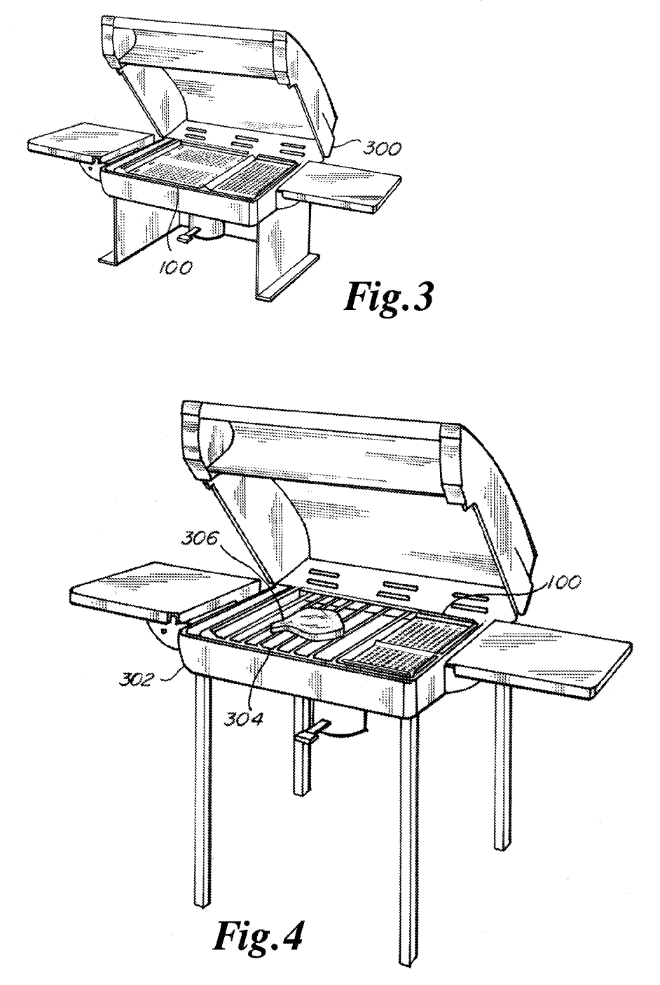

FIGS. 3 and 4 show that the panel is sized and configured for use with both small and large barbeques grills, such as counter-top barbeque grill 300 and full-size grill 302. When used on larger grills such as in FIG. 4, the panel may be set upon the cooking grate 304 off to one side, leaving much of the grate available for cooking other foods 306 which allowing the foods upon the panel to remain isolated there-from. The panel is preferably shaped so that it may be positioned over one burner of a multi-burner grill. Allowing independent control of the cooking temperature on the panel.

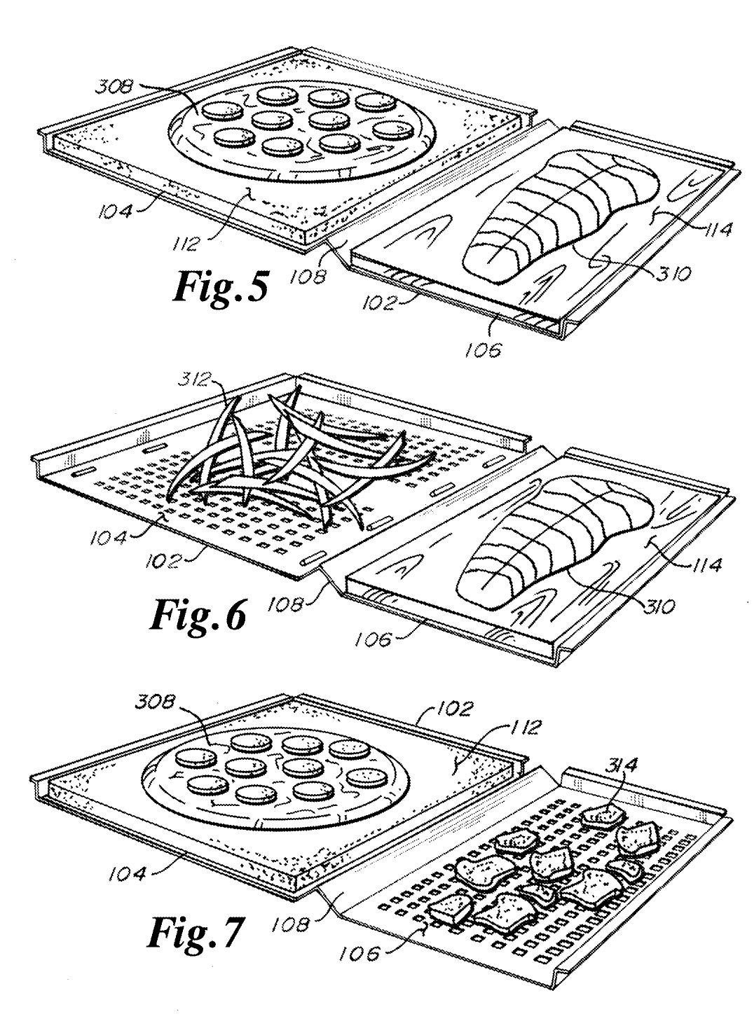

FIGS. 5 through 7 demonstrate several of the many and various combinations of cooking that may be achieved using device 100. For instance, FIG. 5 shows the device using both tile 112 and plank 114 in preparation for simultaneously grilling a pizza 308 and a piece of fish 310 thereon, respectively. FIG. 6 shows the device using the plank 114 in preparation for grilling the fish while simultaneously grilling some vegetables 312 in the first segment that are too thin to otherwise cook directly on the grate. And FIG. 7 shows how one might grill the pizza on the tile in the left section which simultaneously grilling mushrooms 314 in the second segment.

Returning to FIGS. 1 and 2, and also referring to FIG. 8, one can see that the first and second segments of the panel are perforated with three-eighth inch by three-eighth inch square holes 116 spaced on a nine-sixteenths inch grid. As preferably embodied here, the panel is stamped of sheet metal and the holes are punched there-through. But the panel may be fabricated and/or perforated by other methods, such as by the punch-stretch method of making expanded sheet metal, or by die casting or drilling, provided that such is arranged and dimensioned to provide equivalent ventilation and heat-transfer. The three-eighths inch hole size is found optimal for preventing smaller food items from passing through, while allowing adequate ventilation at the nine-sixteenths spacing between holes to expose the food to sufficient heat for cooking and smoke for flavoring.

Raised bosses 118 in the second segment maintain tile 112 in a spaced-above relationship above the panel, which is found preferable for even heat distribution under and across the tile, resulting in a more evenly cooked pizza crust or bread crust. To cook pizza, the panel is preferably placed atop the grate of a lit barbeque grill with the tile thereupon and pre-heated until the tile has reached four-hundred and fifty to five-hundred degrees F., then dry flour of cornmeal is sprinkled atop the heated tile to prevent sticking and the uncooked pizza is placed thereon. The pizza is cooked to the desired degree, during which it is permeated with the smoke and flavor of barbeque. The pizza and tile may be removed together and the pizza may be cut directly on the tile. The tile may be washed at the sink of in a dishwasher after cooking.

To cook foods such as fish or chicken on the wooden plank, the plank is preferably first soaked in water or white wine, then the food is place atop the plank in the panel and the food/plank/panel are placed together atop the preheated grill. The moisture from the soaked wood rises through the food as it cooks to maintain desired moisture while infusing the food with flavors from the wood. Woods such as cedar, hickory, mesquite, and apple are found to each impart a unique and desirable flavor throughout the food. Meanwhile, the upper surface of the food is bathed in smoke and given a crispy and toasted surface, which is both tasteful and appealing to the eye.

Vegetables such as string beans, mushrooms, or sliced squash, are best tossed in vegetable oil and some spices prior to placing directly on the preheated panels, where heat and smoke rise through perforations to cook and flavor, and juiced are drained back to the cooking fire to increase desirable smokiness.

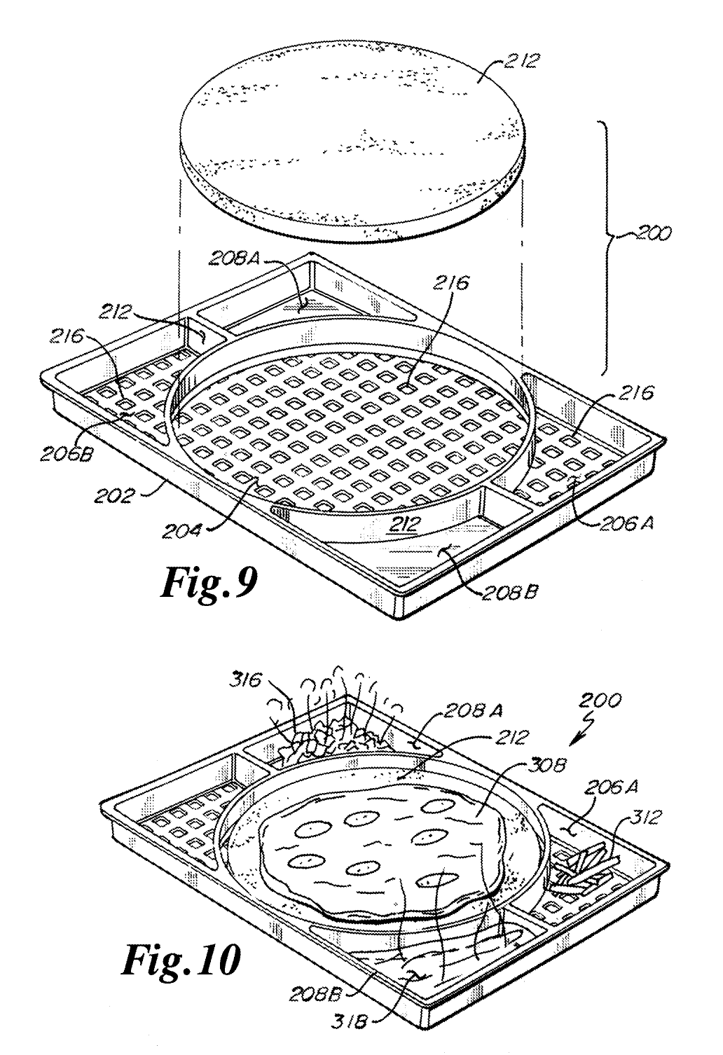

A second exemplary embodiment of a versatile cooking device 200 is shown in FIGS. 9 and 10, and enables the simultaneous grilling of non-traditional or delicate foods such as pizza, vegetables, non-solid foods, and liquids.

Centrally position in metal panel 202 is a large circular perforated first segment 204, surrounded by smaller satellite segments, including both perforated segments 206A and 206B and non-perforated segments 208A and 208B. The segments are all separated from each other by a network of intervening barriers 210. A circular stone tile 212 may be removably received in the first segment, and there-upon may be cooked foods like pizza 308 or bread, as earlier described. Vegetables 312 and small food items may be simultaneously placed and grilled within the perforated satellite segments as previously described. Additionally, the non-perforated satellite segments provide reservoirs for heating non-solid foods such as mashed potatoes 316, or even liquids such as gravy 318. Alternatively, the tile could be replaced with a circular wooden plank for cooking fish and such, as previously described.

As in the previous embodiment, the perforations 216 of the segments are preferably three-eighth inch square holes spaced on a nine-sixteenths inch grid.

The perforated satellite segments are also ideal for adding moistened wood shavings or chips, charring of which during grilling provides authentic hardwood smoke flavor in the grilled foods.

Other uses for the perforated satellite segments may include pre-cooking and warming pizza toppings prior to adding to the pizza, and cooking smaller portions of side items. The non-perforated satellite segments may be used for warming and cooking sauces, both for easy basting onto grilling foods, or for serving at the table.

Various changes in form and detail may be made without departing from the spirit and scope of the invention, so the invention should therefore only be considered according to the following claims, including all equivalent interpretation to which they are entitled.

We claim:

1. A grilling device comprising:
a planar slab; and
a metal panel comprising a perforated first segment, a second segment adapted to removably receive said slab, and a barrier dividing said first and second segments.

2. The device of claim 1 wherein said planar slab is from the group including a wooden plank, a stone tile, and a ceramic tile.

3. The device of claim 2 wherein said perforated first segment comprises perforations of minor dimension smaller than approximately three-eighths of an inch.

4. The device of claim 3 wherein said second segment is a perforated second segment.

5. The device of claim 4 wherein said perforated second segment comprises perforations of minor dimension smaller than approximately three-eighths of an inch.

6. The device of claim 5 wherein said metal panel further comprises a non-perforated third segment.

7. The device of claim 1 wherein said planar slab is from the group including a circular stone tile and a circular ceramic tile.

8. The device of claim 7 wherein said perforated first segment comprises perforations of minor dimension smaller than approximately three-eighths of an inch.

9. The device of claim 8 wherein said second segment is a perforated second segment.

10. The device of claim 9 wherein said perforated second segment comprises perforations of minor dimension smaller than approximately three-eighths of an inch.

11. The device of claim 10 wherein said metal panel further comprises a non-perforated third segment.

12. A metal grilling panel comprising:
a perforated first segment;
a perforated second segment; and
a barrier dividing said first and second segments.

13. The device of claim 12 wherein said perforated first segment comprises perforations of minor dimension smaller than approximately three-eighths of an inch.

14. The device of claim 13 wherein said perforated second segment comprises perforations of minor dimension smaller than approximately three-eighths of an inch.

15. The device of claim 14 further comprising a non-perforated third segment.

16. A grilling device comprising:
first and second planar slabs; and
a metal panel comprising a first segment adapted to removably receive said first slab, a second segment adapted to removably receive said second slab, and a barrier dividing said first and second segments.

17. The device of claim 16 wherein said first planar slab is from the group including a stone tile and a ceramic tile.

18. The device of claim 16 wherein said first planar tile is circular.

19. The device of claim 16 wherein said second planar slab comprises a wooden plank.

20. The device of claim 16 wherein said first segment comprises perforations of minor dimension smaller than approximately three-eighths of an inch.
